(19) United States
(12) Patent Application Publication
(10) Pub. No.: US 2007/0052678 A1
(43) Pub. Date: Mar. 8, 2007

(54) Optical trackball

(75) Inventor: Tao-Shen Chen, Chung Li City (TW)

Correspondence Address: TROXELL LAW OFFICE PLLC;SUITE 1404, 5205 LEESBURG PIKE, FALLS CHURCH, VA, 22041, US

(73) Assignee: Can Technology Co., Ltd.

(21) Appl. No.: 11/217,381

(22) Filed: Sep. 2, 2005

(51) Int. Cl. G09G 5/08

(52) U.S. Cl. 345/167

(57) ABSTRACT

A trackball adapted to an input facility is comprised of a circuit board, a retainer and an optical holder; the retainer containing a trackball; light from a light emitting device on the circuit board being reflected through the optical holder to the trackball; range and orientation of the movement by the trackball being detected by an identification device also disposed on the circuit board to solve the data of the movement of the trackball and transmit the data to a host to control a cursor accordingly.

### BACKGROUND OF THE INVENTION

(a) Field of the Invention

The present invention is related to an optical trackball, and more particularly to one comprised of a light emitting device, an ID device and an optical holder adapted to an input facility that detects and solve a displacement data of distance and orientation by the light project onto the surface of the trackball.

(b) Description of the Prior Art

Referring to FIG. 1 of the accompanying drawings, a construction of a conventional mechanical mouse includes a holder 11, a substrate 14, and two encoding device 12, 13. The holder 11 contains a trackball 111 and is mounted to an appropriate location 15 on the substrate 14. Two opening 124, 134 and encoding devices 12, 13 are respectively provided to where the substrate 14 is abutted to the holder 11. Both encoding devices 12, 13 are respectively comprised of an optical grating wheel 121, 131, a light emitter 122, 132, a light receiver 123, 133 and a wheel rod 125, 135. Wherein, both light grating wheels 121, 131 respectively turn freely between both openings 124, 134. One end of the wheel rod 125, 135 rests upon the trackball 111 to merely drive the wheel rod 125, 135 as the trackball 111 turns around. Meanwhile, another end of the wheel rod 125, 135 is connected to the optical grating wheel 121, 132 to such that the optical grating wheel 121, 132 turns around as the wheel rod 125, 135 does so to revolve within the opening 124, 124. Accordingly, the light radiated from the light emitter 122, 132 are received by the light receiver 123, 133 through multiple ling pores 126, 136 disposed on the optical grating wheel 121, 132 for the light emitter 122, 132 on one side and the light receiver 123, 133 on the opposite side of the opening 124, 134. Once the trackball 111 turns around and drives the wheel rods 125, 135, both optical grating wheels 121, 132 respectively revolve within the openings 124, 134 for a decoding circuit to solve movement data and transmit them to a host, such as a desktop computer or a notebook depending on the changes of the lights projected to the light receivers 123, 133 through those light pores 126, 136 for the host to control a cursor on a monitor connected to the host according to the data of movement.

However, it is not practical to install the mechanical construction of the mouse into an input facility, e.g., a keyboard, numeric keypad, remote control or joystick due to the casing of the mouse is prevented from being reduced as it has to accommodate the complicated design of the mechanism for the mouse.

### SUMMARY OF THE INVENTION

The primary purpose of the present invention is to provide an improved construction for an optical trackball to control the cursor to move to a specific location that eliminates the flaw of preventing the conventional mechanical mouse from being easily adapted to an input facility.

To achieve the purpose, a retainer is disposed in the casing that contains a trackball at where closer to the surface of the casing, and a space to accommodate the trackball is provided at where closer to its center. Two circular holes are respectively provided on the side where the retainer is abutted to the casing and on the opposite side for the trackball to be respectively exposed out of both relative sides of the retainer. Multiple positioning nipples are disposed on the side where the accommodation space of the retainer contacts the trackball. An optical holder is disposed in the casing at where turning away from the retainer and is contained in an opening disposed on the circuit board. A light-emitting device is disposed on the retainer at where facing the optical holder. The light is directed to project on the optical holder to be reflected by the optical holder onto the trackball. An identification device is disposed at where exactly aligned at the opening of the circuit board to detect the distance and origination of the movement of the area on the trackball is projected to solve data of a displacement and transmit the data to the host.

### BRIEF DESCRIPTION OF THE DRAWINGS

FIG. 1 is a schematic view of a mechanical mouse of the prior art.

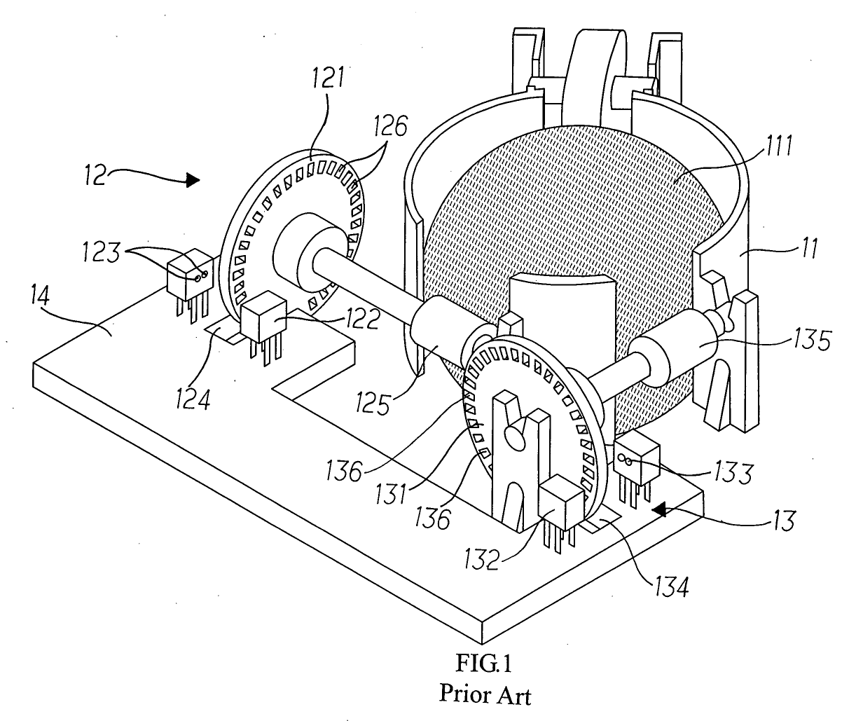

FIG. 2 is a schematic view showing a trackball of the present invention is disposed inside a keyboard.

FIG. 3 is perspective view of the trackball of the, present invention.

FIG. 4 is an exploded view of the trackball of the present invention.

FIG. 5 is a schematic view showing the trackball of the present invention.

### DETAILED DESCRIPTION OF THE PREFERRED EMBODIMENTS

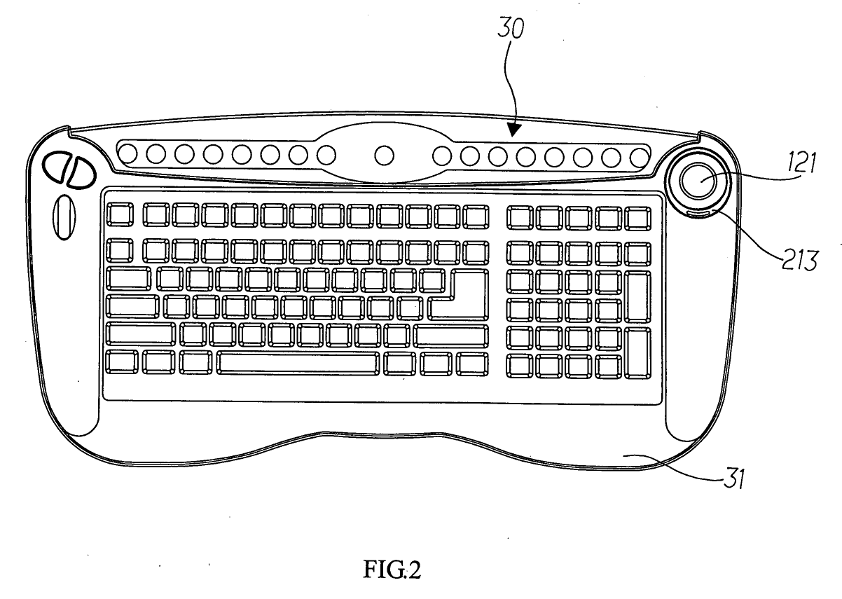

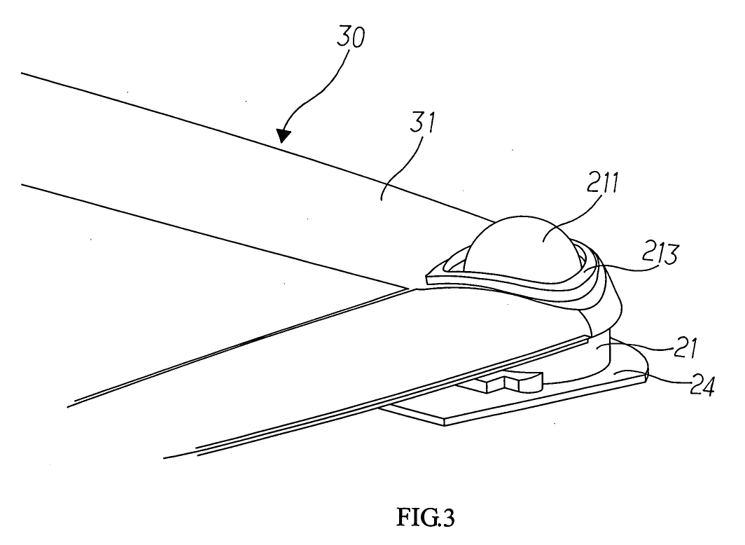

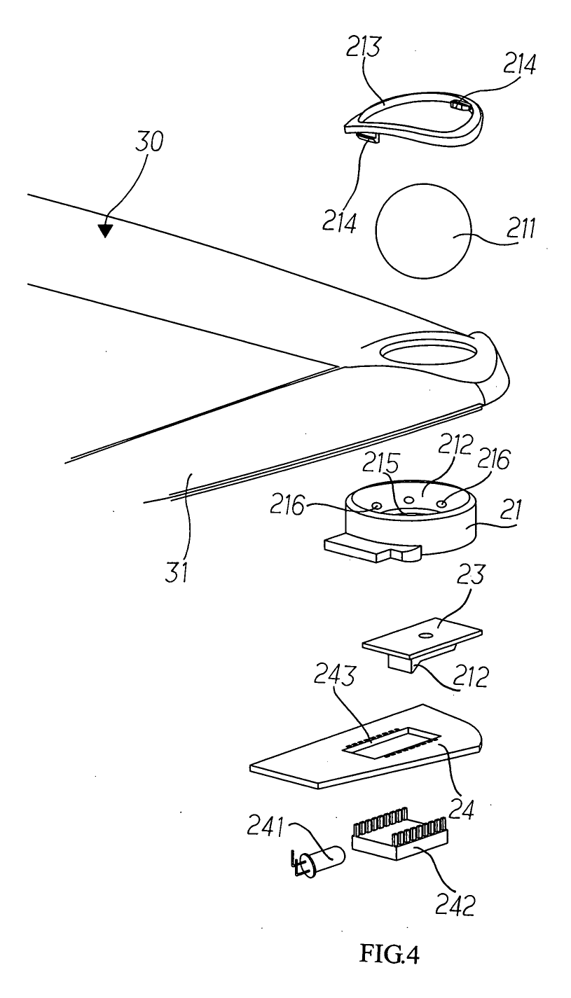

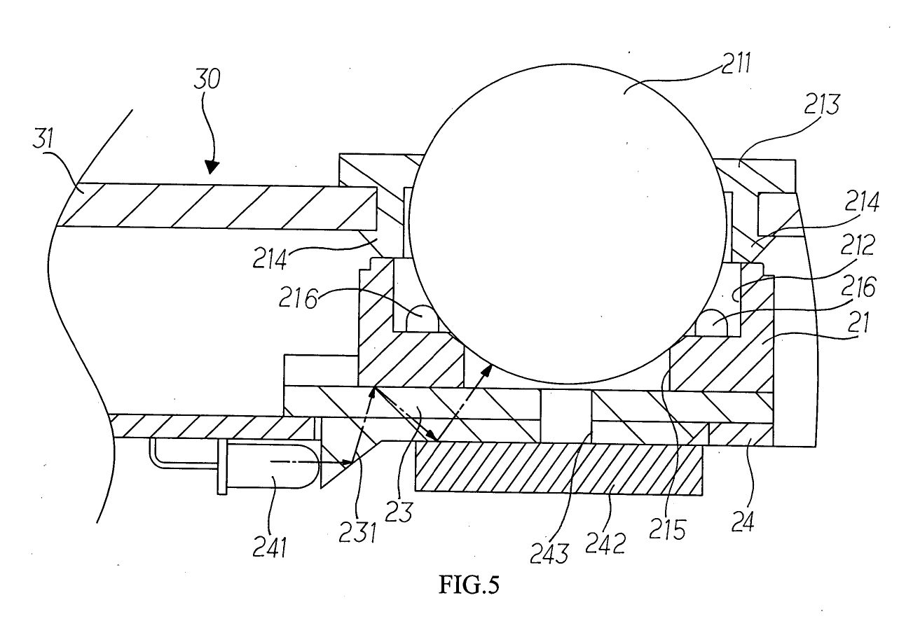

Referring to FIGS. 2 and 3, an optical trackball is installed in a casing 31 of an input facility 30, such as a keyboard, remote control, joystick, or a numeric keypad. As illustrated in FIGS. 4 and 5, the construction of the optical trackball is comprised of a trackball 211, a retainer 21, an optical holder 23, and a circuit board mounted in sequence from the surface to the bottom of the casing 31.

Wherein, the trackball 211 is provided in the retainer 21 and partially exposed respectively out of two relative sides of the casing 31. A light-emitting device 241 is disposed on the circuit board 24 at where it is abutted to the optical holder 23 with the light emitted from the light-emitting device to be reflected through the optical holder onto the surface of the trackball 211. An identification device 242 is provided on the circuit board at where in relation to where the trackball 211 is located to detect the distance and orientation of the movement by the part of the trackball 21 projected by the light and to solve data of displacement of the light projected area on the trackball 211 and transmit the data to a host, e.g., a PC, where the host controls a cursor on a monitor (not illustrated) externally connected to the host based on the data received.

In another preferred embodiment of the present invention, the retainer 21 is disposed in the casing 31 at where closer to the surface of the casing 31 and a space 212 is provided at were close to the center of the retainer 21 to accommodate the trackball 211. A locking ring 2132 is provided above the trackball and is latched to the casing by means of a locking member 214. As illustrated, the locking means related to a pair of hooks that locks the locking ring 213 to the casing 31 to confine the trackball 211 in the retainer 21. Two circular holes 215 are respectively provided on one side of the retainer 21 is abutted to the surface of the casing 31 and another side of the retainer 21 turning away from the casing to partially expose the trackball out of two relative sides of the retainer 21. Multiple nipples 216 are provided on the edge where the accommodation space 213 contacts the trackball 211 to apply resilience to hold the trackball 211 in position.

The optical holder 23 is disposed in the casing 31 at where turning away from the location of the retainer 21 is provided and is received in the opening 243 disposed at the circuit board 24. One end of the optical holder 23 is disposed with a reflection part 231 and a light-emitting device 241 is disposed at where facing the optical holder 23 thus for the optical holder 23 to reflect the light onto the surface of the trackball 211. The identification device 242 is provided to the circuit board 24 on the side the circuit board 24 is turning away from the retainer 21 facing the opening 243 of the circuit board is provided for transmitting displacement data to the host, e.g., a desktop computer or notebook.

As illustrated in FIGS. 4 and 5, with the optical holder 23 confined in the opening 243, the optical holder 23 is merely aligned at the light-emitting device 241 and the identification device 242 is aligned at the opening 243. The light from the light-emitting device 241 is reflected by the reflection part 231, passing through the opening 243 and the circular hole 215 to reach the trackball 211. The identification device 241 detects the distance and orientation of the movement by the area on the trackball 21 projected by the light. Once the trackball 21 is turned around, the identification device 242 detects the distance and orientation of the trackball 211 travels to solve the displacement data and transmit the data to the host by a cabled or wireless transmission method, e.g., radio, infrared and Bluetooth, for the host depending on the data received to control the cursor on a monitor externally connected to the host.

Now refer to FIG. 2, a control circuit (not marked) is disposed in the input facility for the control circuit to be merely interconnected to each other. Displacement data solved by the identification device are transmitted to the control circuit, where, the displacement data are transmitted to the host. Accordingly, the construction of the optical trackball of the present invention shares the same transmission wire (or via radio) with the input facility to transfer the data.

The prevent invention provides an improved structure of an optical trackball, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. An improved construction of a trackball built in a casing of an input facility, the casing containing a control circuit that is electrically connected to a host; a retainer being disposed in the casing at where closer to its surface; two circular holes being respectively provided to the retainer on one side closer to and another side away from the surface of the casing; the trackball being exposed out of those two circular holes of the retainer; multiple positioning nipples being disposed on the side where the accommodation space of the casing contacts the trackball; an optical holder being disposed in the casing at where facing away the location of the retainer and received in an opening of the circuit board; a light emitting device being disposed at where facing the optical holder; the light source being projected to the optical holder to be reflected onto the trackball through the optical holder; an identification device being disposed exactly aligned at where the opening is located; distance and orientation of the movement of the trackball on its surface projected by the light source being detected by the identification device through the opening of the light projected, and displacement data of the distance and orientation of the movement being solved and transmitted to the host.

2. The improved construction of a trackball of claim 1, wherein a locking ring is separately provided above the trackball and a pair of locking members snap the locking ring onto the casing of the input facility.

3. The improved construction of a trackball of claim 2, wherein each of the pair of the locking members is related to a hook.

4. The improved construction of a trackball of claim 1, wherein, the input facility relates to a keyboard.

5. The improved construction of a trackball of claim 1, wherein the input facilities related to a number keypad.
